(19) United States
(12) Patent Application Publication
(10) Pub. No.: US 2023/0401464 A1
(43) Pub. Date: Dec. 14, 2023

(54) SYSTEMS AND METHODS FOR MEDIA DISCOVERY

(71) Applicant: Spotify AB, Stockholm (SE)

(72) Inventors: Ziwei FAN, Chicago, IL (US); Alice WANG, New York, NY (US); Zahra NAZARI, New York, NY (US)

(21) Appl. No.: 17/860,019

(22) Filed: Jul. 7, 2022

Related U.S. Application Data
(60) Provisional application No. 63/351,264, filed on Jun. 10, 2022.

(51) Int. Cl. G06N 5/04

(52) U.S. Cl. CPC G06N 5/04

(57) ABSTRACT

The various implementations described herein include methods and devices for media discovery. In one aspect, a method includes obtaining a pre-trained recommender model that has been trained using contrastive learning with feature-level augmentation and instance-level augmentation. The method further includes generating, via the model, a user embedding based on features of the user and generating, via the model, a respective episode embedding for each episode of a plurality of episodes, each respective episode embedding based on features of the corresponding episode. The method also includes generating, via the model, a respective similarity score (corresponding to a latent similarity between the user embedding and each respective episode embedding) for each episode, the respective similarity score, and ranking the episodes in accordance with the respective similarity scores. The method further includes recommending the highest ranked episode to the user.

### PRIORITY AND RELATED APPLICATIONS

This application claims priority to U.S. Provisional App. No. 63/351,264, filed Jun. 10, 2022, entitled “Systems and Methods for Media Discovery,” which is incorporated by reference herein in its entirety.

### TECHNICAL FIELD

The disclosed embodiments relate generally to media provider systems including, but not limited to, systems and methods for discovering and recommending media to users.

### BACKGROUND

Recent years have shown a remarkable growth in consumption of digital goods such as digital music, movies, books, and podcasts, among many others. The overwhelmingly large number of these goods often makes navigation and discovery of new digital goods an extremely difficult task. Recommender systems commonly retrieve preferred items for users from a massive number of items by modeling users' interests based on historical interactions. However, reliance on historical interaction data is limiting for user exploration and item discovery. This problem is further aggravated for the discovery of novel or cold-start items.

### SUMMARY

Recommender Systems (RS) are applied to web applications to retrieve relevant information. Recommender Systems can provide personalized recommendations of items to alleviate information overload for users, e.g., recommendations for audio streaming and online shopping. Collaborative filtering (CF) is employed by some Recommender Systems and assumes that users with similar interests prefer similar items. For example, with CF the users' interests are modeled or optimized by historical interactions. CF systems can embed users and items as latent representation vectors, with features as inputs (e.g., either pure IDs or pre-processed feature vectors).

However, because CF-based Recommender Systems model interest based on historical interactions, these systems may fail to identify topics that users would be interested in but may not know about (e.g., have no prior historical interaction). Therefore, a challenge for RS is to facilitate user exploration. Exploration is increasingly a problem in RS, as existing RS methods can cause echo chambers and filter bubbles as users increasingly engage with RS. This phenomenon may optimize short-term user interests and can fail to drive long-term user engagement. A lack of diversity of recommended items can also reduce user satisfaction.

New and diverse podcast content is increasingly and continuously being created. However, user exploration of new podcasts has several challenges, including feature sparsity and interaction sparsity. These challenges can result from a data sparsity problem in RS, where limited interaction data is available for representing users and items. Specifically, feature sparsity can be due to many podcasts being cold-start items with few user interactions. Additionally, a lack of user-item interaction is inherent in recommending new content to users.

The disclosed embodiments include a recommendation system to assist users with episode discovery for podcasts and other media. Episode discovery involves a user interacting with an episode from a podcast with which the user has never before interacted. Some conventional recommendation systems rely on historical user-interactions and therefore have a sparsity problem when recommending new shows (e.g., cold-start items) with few user interactions (e.g., an inherently small training set). For example, the new shows may have 10 or less positive interactions. A positive interaction can include a user listening for at least a preset amount of time (e.g., 30 seconds, 1 minute, or 2 minutes). The recommendation system described herein uses (i) a two-tower model, and (ii) a contrastive learning approach to improve performance and help users discover new shows in accordance with some embodiments. For example, a two-tower model determines a latent similarity between a user embedding and an episode embedding. A contrastive learning approach can include feature-level augmentation (e.g., feature dropout layer(s)) to obtain augmented episode embeddings. The contrastive learning approach can also include instance-level augmentation (e.g., identifying similar episodes using semantics, cosine similarity, and/or knowledge graph information) to obtain correlated episode embeddings. Thus, the contrastive learning approach can increase the size of the training set for the two-tower model (e.g., to overcome the sparsity problem).

In accordance with some embodiments, a method of recommending content to a user is provided. The method is performed at a computing device having one or more processors and memory. The method includes: (1) obtaining a pre-trained recommender model, where the pre-trained recommender model is trained using contrastive learning with feature-level augmentation and instance-level augmentation; (2) generating, via the pre-trained recommender model, a user embedding based on a plurality of features of the user; (3) generating, via the pre-trained recommender model, a respective episode embedding for each episode of a plurality of episodes, each respective episode embedding based on a plurality of features of the corresponding episode; (4) generating, via the pre-trained recommender model, a respective similarity score for each episode of a plurality of episodes, the respective similarity score corresponding to a latent similarity between the user embedding and each respective episode embedding; (5) ranking the plurality of episodes in accordance with the respective similarity scores; and (6) recommending a highest ranked episode of the plurality of episodes to the user.

In accordance with some embodiments, an electronic device is provided. The electronic device includes one or more processors and memory storing one or more programs. The one or more programs include instructions for performing any of the methods described herein (e.g., the method 700).

In accordance with some embodiments, a non-transitory computer-readable storage medium is provided. The non-transitory computer-readable storage medium stores one or more programs for execution by an electronic device with one or more processors. The one or more programs comprising instructions for performing any of the methods described herein (e.g., the method 700).

Thus, methods and systems are disclosed that identify and recommend content and media to users. Such methods and systems may complement or replace conventional methods and systems of identifying and recommending content and media to users.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating a media content delivery system in accordance with some embodiments.

FIG. 2 is a block diagram illustrating an electronic device in accordance with some embodiments.

FIG. 3 is a block diagram illustrating a media content server in accordance with some embodiments.

FIG. 4 is a block diagram illustrating a discovery system in accordance with some embodiments.

FIG. 5 is a block diagram illustrating a recommender framework in accordance with some embodiments.

FIGS. 6A-6B are block diagrams illustrating augmentation frameworks in accordance with some embodiments.

FIGS. 7A-7B are flow diagrams illustrating a method of recommending content to a user in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

The disclosed embodiments include a two-tower recommender framework with contrastive learning to improve recommendations for discovery and exploration. Contrastive learning involves learning to compare items and can be used to enhance an encoder network. In some embodiments, two types of contrastive learning are combined: feature augmentation using feature drop-out during training, and instance-level augmentation. For example, feature augmentation for images may include rotation, color changes, cropping, and the like. For instance-level augmentation, semantic similarity between episodes can be used (e.g., using cosine-similarity between pre-trained embeddings of episodes) to assist the model in learning which episodes are similar to one another and help users to discover items that are semantically similar to their past listening.

Some embodiments include a framework (e.g., a two-tower architecture) with hierarchical data augmentations in contrastive learning. Data augmentation enriches data with different views of similar items (e.g., for learning item embeddings), and contrastive learning acts as a bridge connecting augmented items and positively interacted items. In accordance with some embodiments, the disclosed framework incorporates a feature level augmentation (e.g., fine granularity) and an instance level augmentation (e.g., coarse granularity). For feature level augmentation, a feature dropout technique to randomly mask a subset of item features can be used so that some sparse features are trained to better infer the item embedding. For instance level augmentation, similar items from different semantic item relationships are incorporated as positive items to enrich scarce user-item interactions. Thus, in accordance with some embodiments, a data augmentation framework is disclosed to alleviate data sparsity in user exploration and recommendation from two perspectives: (1) feature augmentation for feature sparsity, and (2) instance augmentation for user-item explorative interactions sparsity.

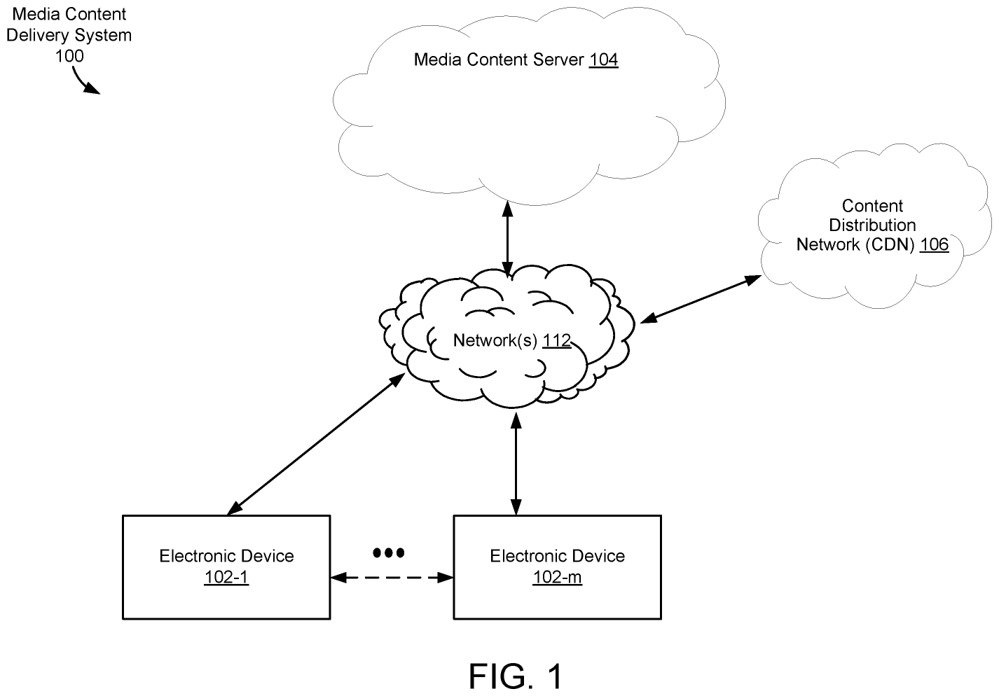

FIG. 1 is a block diagram illustrating a media content delivery system 100 in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, an infotainment system, digital media player, a speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

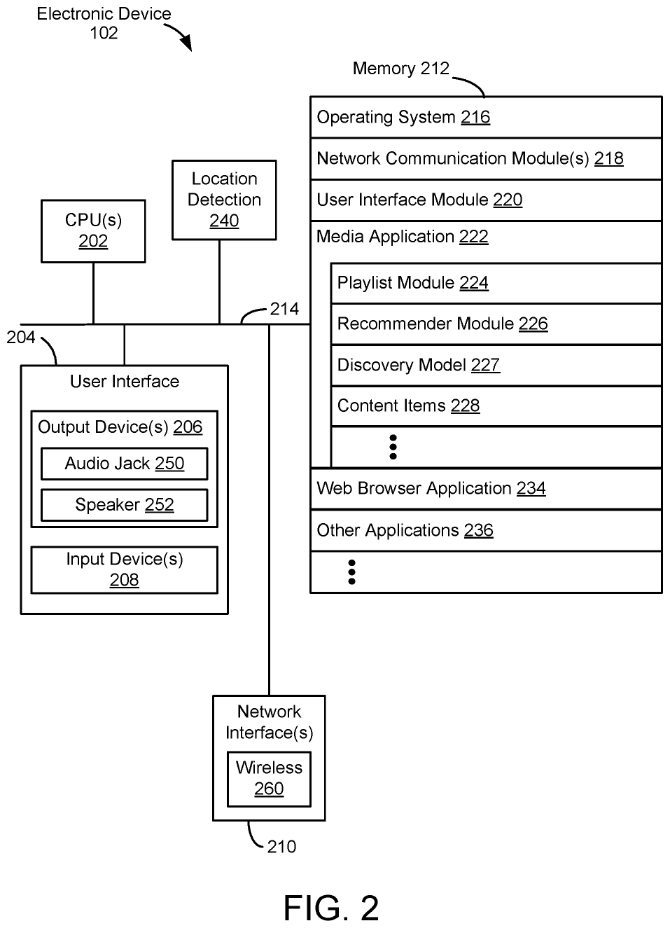

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice API, a connect API, and/or key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), e.g., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

Optionally, the electronic device 102 includes a location-detection device 240, such as a global navigation satellite system (GNSS) (e.g., GPS (global positioning system), GLONASS, Galileo, BeiDou) or other geo-location receiver, and/or location-detection software for determining the location of the electronic device 102 (e.g., module for finding a position of the electronic device 102 using trilateration of measured signal strengths for nearby devices).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11 a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the client device 102 to other computing devices (e.g., media presentation system(s), media content server 104, and/or other client devices) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items). In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof:
   a playlist module 224 for storing sets of media items for playback in a predefined order;
   a recommender module 226 for identifying and/or displaying recommended media items to include in a playlist;
   a discovery model 227 for identifying and presenting media items to a user;
   a content items module 228 for storing media items, including audio items such as podcasts and songs, for playback and/or for forwarding requests for media content items to the media content server;
a web browser application 234 for accessing, viewing, and interacting with web sites; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

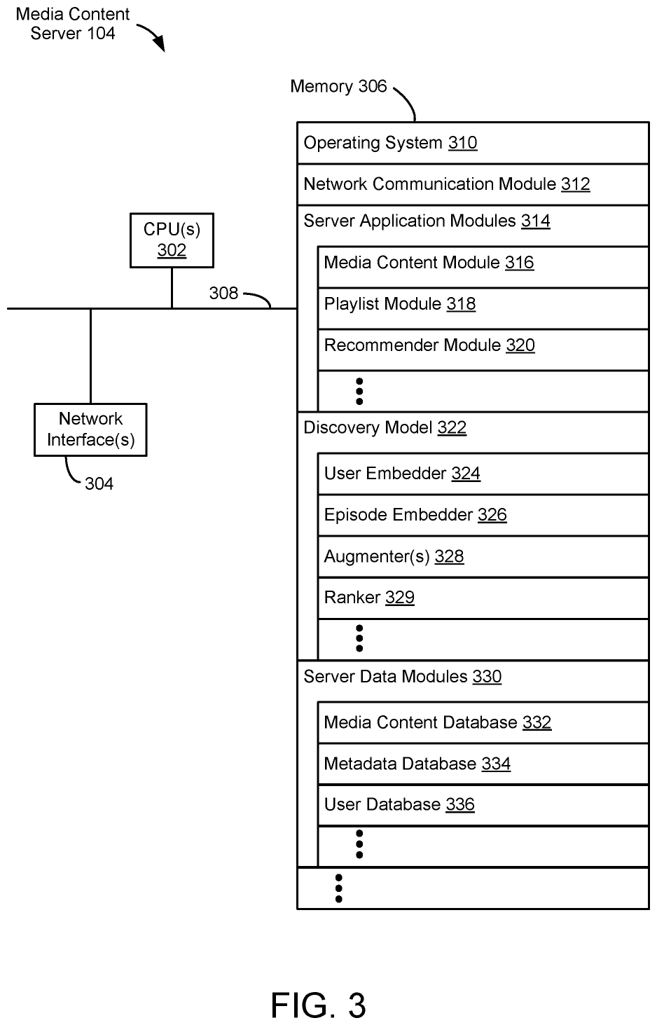

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a media content module 316 for storing one or more media content items and/or sending (e.g., streaming), to the electronic device, one or more requested media content item(s);
   a playlist module 318 for storing and/or providing (e.g., streaming) sets of media content items to the electronic device;
   a recommender module 320 for determining and/or providing recommendations;
a discovery model 322 for identifying and recommending media content items for one or more users including, but not limited to, one or more of:
   a user embedder 324 for generating a user embedding from user features, e.g., from a user profile and/or historical usage;
   an episode embedder 326 for generating an episode embedding from episode features, e.g., from metadata associated with the episode (media item);
   one or more augmenters 328 for performing feature level augmentation (e.g., a dropout layer) and/or instance level augmentation (e.g., identifying semantically similar episodes); and
   a ranker 329 for ranking episodes based on similarity scores;
one or more server data module(s) 330 for handling the storage of and/or access to media items and/or metadata relating to the media items; in some embodiments, the one or more server data module(s) 330 include:
   a media content database 332 for storing media items;
   a metadata database 334 for storing metadata relating to the media items, including a genre associated with the respective media items; and
   a user database 336 for storing user profile data, historical usage data, and/or preferences data.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (e.g., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 334 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

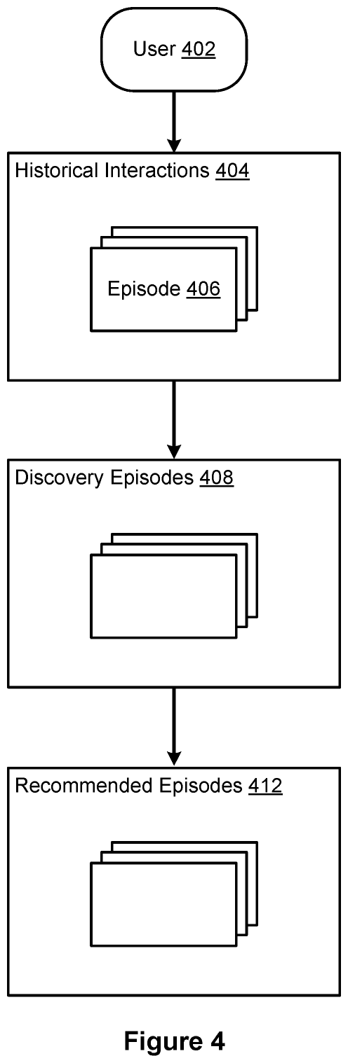

FIG. 4 is a block diagram illustrating a discovery system in accordance with some embodiments. As shown in FIG. 4, a user 402 interacts with multiple episodes 406. Based on these historical interactions 404, discovery episodes 408 are identified. The discovery episodes are episodes that the user has not interacted with previously. The discovery episodes are ranked to provide one or more recommended episodes 412 for the user 402.

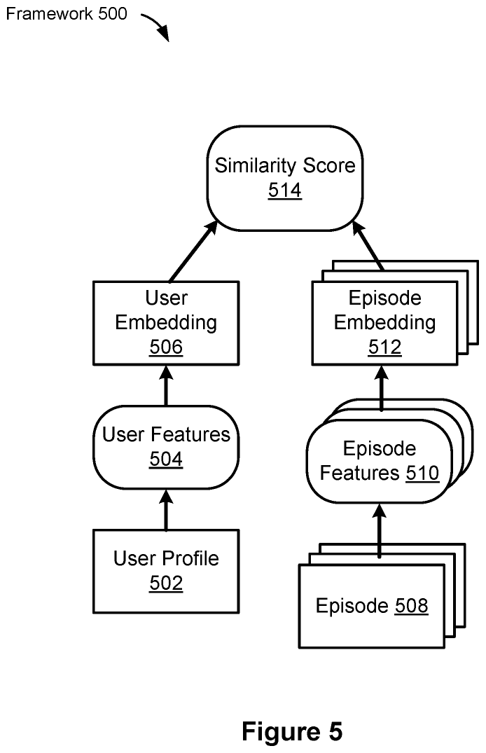

FIG. 5 is a block diagram illustrating a recommender framework 500 in accordance with some embodiments. The recommender framework 500 includes two paths (towers). One path includes obtaining user features 504 (e.g., a user feature vector) from a user profile 502 (e.g., preferences and usage history). In some embodiments, the user features 504 include one or more of: gender, age, location, preferences, and usage history (e.g., the historical interactions 404). In some embodiments, the user features include one or more of: gender, age, country, podcast topics liked in a previous time period (e.g., 30, 60, or days), a user language, a pre-trained collaborative filtering embedding vector, a user embedding pre-trained with podcast interactions, and an averaged streaming time. A user embedding 506 is generated from the user features 504. In some embodiments, a multilayer perceptron (MLP) or feedforward artificial neural network (ANN) is used for user feature 504 transforms.

The other path includes obtaining episode features 510 (e.g., an episode feature vector) for each episode of one or more episodes 508. In some embodiments, the episode features 510 include one or more of: episode topic, episode title, episode genre, and episode consumption data. In some embodiments, the episode features for a podcast include one or more of: topics, country, collaborative filtering pre-trained embeddings, and pre-trained semantic embeddings of the podcast. A respective episode embedding 512 is generated from each set of episode features 510. In some embodiments, an MLP or feedforward ANN is used for episode feature 510 transforms. A similarity score 514 (e.g., a preference score) is generated for the user embedding 506 and each episode embedding 512. In some embodiments, for discrete features, the features are encoded as one-hot or multi-hot vectors. In some embodiments, for continuous features, such as pre-trained embedding vectors, the features are input directly. In some embodiments, after encoding, all of the features for the user are concatenated and all of the features for the episode are concatenated.

In accordance with some embodiments, an episode exploration recommender rᵤᵢ (e.g., a two-tower model) is defined by:

[symbol]

=Fᵤ(fᵤ)^{T}Fᵢ(fᵢ) Equation 1: Exploration Recommender

where u denotes a user in a user set U and i denotes an episode in an episode set I. In some embodiments, the episode i belongs to a podcast show p, where p belongs to a set of podcast shows P. In Equation 1, the vector fᵤ represents a user feature vector and the vector fᵢ represents an episode feature vector. Fᵤ and Fᵢ in Equation 1 represent neural networks for learning user embeddings and episode embeddings. In some embodiments, an episode exploration recommendation list is generated by ranking the rᵤᵢ on all episodes (e.g., in descending order).

In some embodiments, the neural networks Fᵤ and Fᵢ are defined by:

Fᵤ^{L}=ReLU(Fᵤ^{L-1}W₁^{L}+b₁^{L})

Fᵢ^{L}=ReLU(Fᵢ^{L-1}W₂^{L}+b₂^{L}) Equations 2: User and Episode Neural Networks

where ReLU( ) represents a rectified linear unit (ReLU) activation function, W_{*}^{L} represents a linear transformation, and b_{*}^{L} represents a bias. For example, the 0-th layer of each tower is the input feature vector of fᵤ and fᵢ respectively. In some embodiments, the last layer output embedding is used to make predictions, e.g., as in Equation 1 above. In some embodiments, the neural networks in Equations 2 are L-th layers fully connected neural networks.

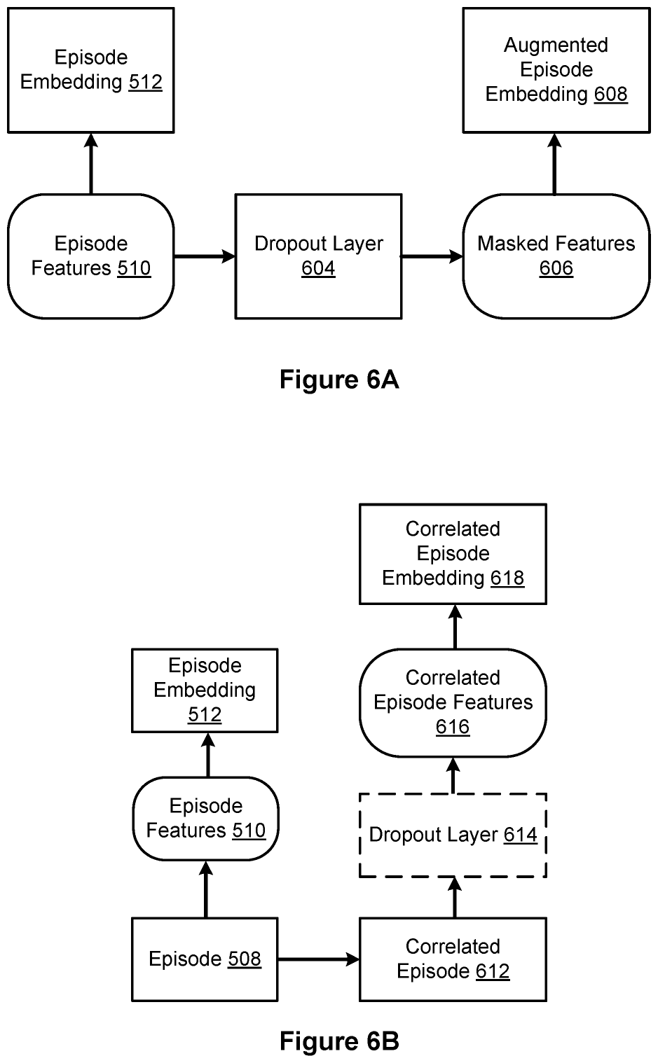

In some circumstances, contrastive learning maximizes the alignment between two views of one instance (e.g., a positive pair). The construction of the positive pair (e.g., type of data augmentation) varies. For example, injecting noise in the input data to create different views or jointly modeling multi-modal information from the same object. With the advantage of data augmentation, contrastive learning improves over zero-shot (e.g., zero or limited data for predicting classes) settings, which is similar to a cold start scenario in recommender systems with each item viewed as a class. The frameworks in FIGS. 6A-6B, described below, can alleviate challenges at both the feature level and instance level.

FIGS. 6A-6B are block diagrams illustrating augmentation frameworks in accordance with some embodiments. FIG. 6A shows an example augmentation architecture that includes generating masked features 606 by applying a dropout layer 604 to the episode features 510. In some embodiments, two or more dropout layers 604 are applied to the episode features 510. An augmented episode embedding 608 is generated from the masked features 606. In some embodiments, the augmented episode embedding 608 is generated using a same encoder as used for generating the episode embedding(s) 512.

In a cold start scenario, features specific to cold episodes have limited interactions and optimization opportunities for cold features may not be well trained. In some embodiments, a subset of input features is randomly masked to enforce the model capability of learning without popular features (e.g., to alleviate cold start issues). In some situations, this masking helps the model generate accurate recommendations with cold features.

FIG. 6B shows an example augmentation architecture that includes identifying correlated episode(s) 612 and generating correlated episode features 616 from each correlated episode 612. In some embodiments, the correlated episode(s) 612 are identified using top-N cosine similarity, knowledge correlations, content correlations (e.g., using a BERT model). In some embodiments, a dropout layer 614 is used to generate masked correlated episode features. A correlated episode embedding 618 is generated from the correlated episode features 616. In some embodiments, the correlated episode embedding 618 is generated using a same encoder as used for generating the episode embedding(s) 512. In some embodiments, knowledge graph embeddings are obtained by applying an embedding process on a graph that contains metadata on podcasts, such as topic nodes, episode nodes, licensor nodes, and publisher nodes. In some embodiments, content embeddings are obtained using pre-trained BERT embeddings on podcast content.

In some situations, in addition to feature level augmentation, the scarcity of user-episode interactions is a significant component of recommendation for discovery and exploration. Some embodiments include generating positive episodes from additional item similarity semantic relationships, including episodes with similar text content and episodes with similar knowledge information. In some embodiments, a user is assumed to be more likely to explore new items with similar content or correlated knowledge to items they have interacted with in the past.

In some embodiments, for each episode i, pre-trained content embeddings and knowledge embeddings are used as side information. In some embodiments, the content embeddings are pre-trained with the episode script and title text. In some embodiments, the knowledge embeddings are pre-trained from episode knowledge graph data. In some embodiments, an Approximate Nearest Neighbors lookup with Annoy architecture is used to extract the top-K similar episodes from each semantic relationship. In some embodiments, top-K similar episodes are extracted by ranking the top-K episodes (e.g., the top 10, 20, or 30 episodes) with smallest L2 distances on content embeddings or knowledge embeddings, respectively.

In some embodiments, positive episodes are generated either from feature dropout, similar semantic relationships, or both. In some embodiments, given a batch of N user-episode exploration interactions, one positive episode is augmented (e.g., an augmented episode is generated) for each episode. In this way, 2N episodes are obtained and a pairing of episodes and augmented episodes results in one positive pair and 2(N−1) negative pairs. In some embodiments, for each episode pair, and the pair features, learned embeddings are obtained after L-layers of the episode tower. In some embodiments, the loss for optimization is defined as:

$${ℒ}_{CL} ( {F}_{{i}_{2 k - 1}}^{L} , {F}_{{i}_{2 k}}^{L} ) = - log \frac{exp ( \begin{matrix}{F}_{{i}_{2 k - 1}}^{L} & {}^{T} {F}_{{i}_{2 k}}^{L}\end{matrix} )}{{\sum }_{m = 1}^{2 N - 1} exp ( \begin{matrix}{F}_{{i}_{2 k - 1}}^{L} & {}^{T} {F}_{{i}_{m}}^{L}\end{matrix} )} \\ Loss Optimization \qquad Equation 3$$

where (Fᵢ_{_{2k−1}}^{L}, Fᵢ_{₂ₖ}^{L}) are learned embeddings for an episode pair (i₂ₖ₋₁, i₂ₖ). In accordance with some embodiments, in Equation 3 a dot product is maximized between the positive and augmented episodes (Fᵢ_{_{2k−1}}^{L}, [symbol] ) which matches the user-episode exploration prediction defined in Equation 1.

In some embodiments, a sampled softmax cross-entropy loss function is used as the user-episode exploration interaction optimization, which incorporates the contrastive loss in Equation 3 as regularization. In accordance with some embodiments, the softmax cross-entropy loss function is defined as:

$$ℒ = - {\sum }_{( u , i ) ∈ ℛ} [ log ( σ ( {r}_{ui} ) ) + {\sum }_{j = 1}^{k} log ( 1 - {r}_{uj} ) ] + λ {ℒ}_{CL} \\ Softmax Cross - Entropy Loss Function \qquad Equation 4$$

where k negative items are sampled in interactions optimization.

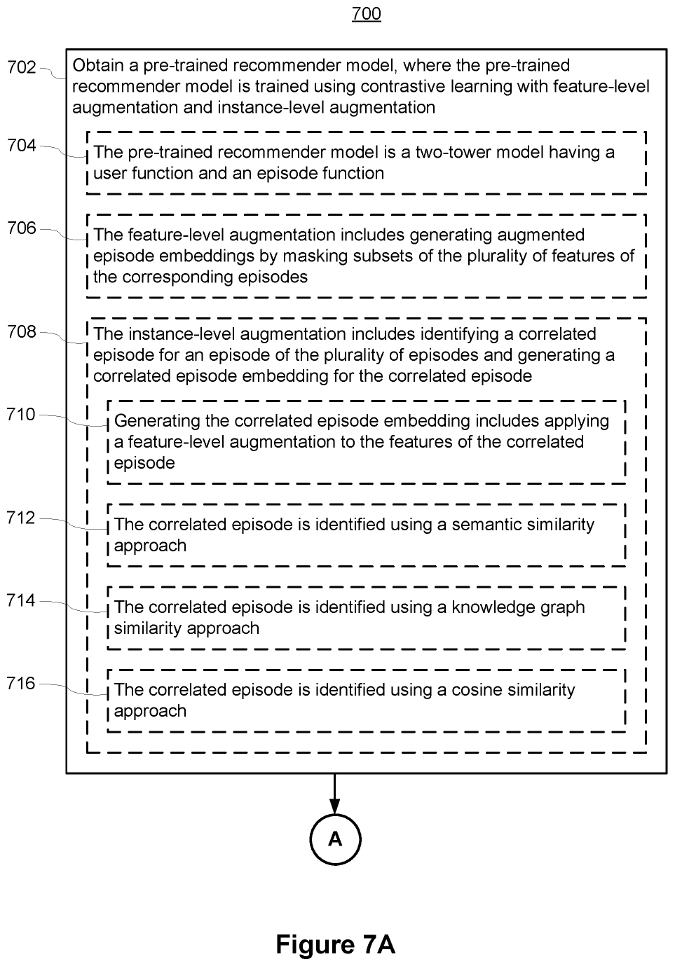

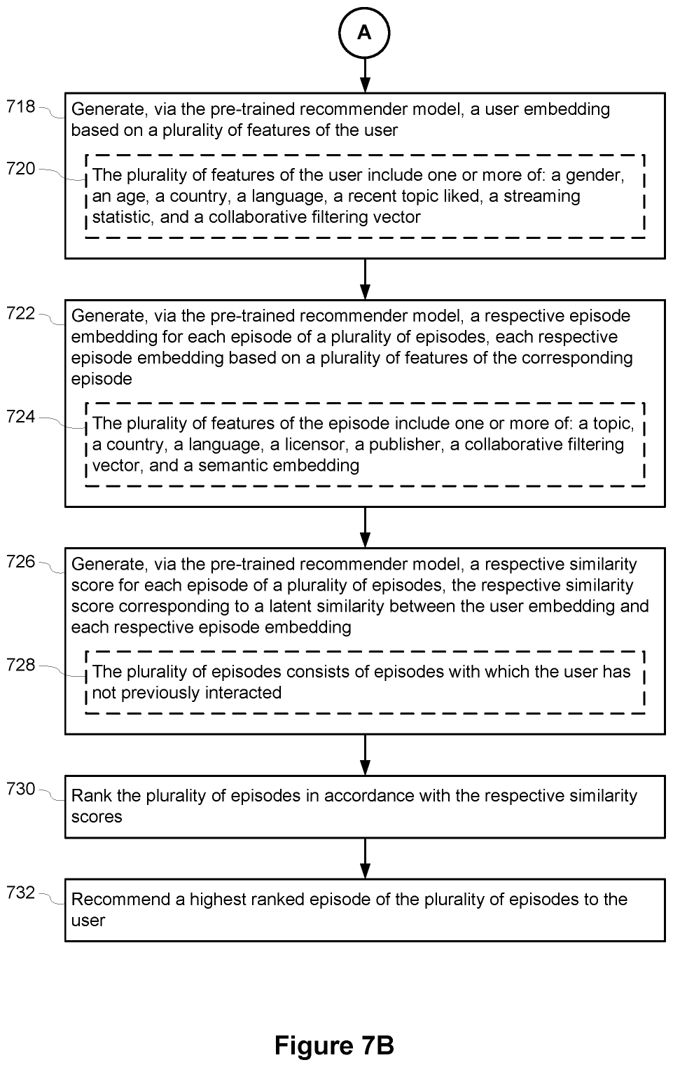

FIGS. 7A-7B are flow diagrams illustrating a method 700 of recommending content to a user in accordance with some embodiments. The method 700 may be performed at a computing system (e.g., media content server 104 and/or electronic device(s) 102) having one or more processors and memory storing instructions for execution by the one or more processors. In some embodiments, the method 700 is performed by executing instructions stored in the memory (e.g., memory 212, FIG. 2, memory 306, FIG. 3) of the computing system. In some embodiments, the method 700 is performed by a combination of the server system (e.g., including media content server 104 and CDN 106) and a client device.

The system obtains (702) a pre-trained recommender model, where the pre-trained recommender model is trained using contrastive learning with feature-level augmentation (e.g., as illustrated in FIG. 6A) and instance-level augmentation (e.g., as illustrated in FIG. 6B). For example, the pre-trained recommender model is an instance of the discovery model 227 or the discovery model 322.

In some embodiments, the pre-trained recommender model is (704) a two-tower model having a user function and an episode function (e.g., the framework 500 illustrated in FIG. 5). In some embodiments, the user function includes the user embedder 324 and the episode embedder 326.

In some embodiments, the feature-level augmentation includes (706) generating augmented episode embeddings by masking subsets of the plurality of features of the corresponding episodes (e.g., using the augmenter(s) 328). For example, the augmented episode embedding 608 is generated by masking subsets of the episode features 510 of the corresponding episode (e.g., using the dropout layer 604).

In some embodiments, the instance-level augmentation includes (708) identifying a correlated episode (e.g., the correlated episode 612) for an episode of the plurality of episodes and generating a correlated episode embedding (e.g., the correlated episode embedding 618) for the correlated episode (e.g., using the augmenter(s) 328).

In some embodiments, generating the correlated episode embedding includes (710) applying a feature-level augmentation to the features of the correlated episode (e.g., the dropout layer 614).

In some embodiments, the correlated episode is identified (712) using a semantic similarity approach (e.g., using a transformer model such as BERT). In some embodiments, the correlated episode is identified (714) using a knowledge graph similarity approach. In some embodiments, the correlated episode is identified (716) using a cosine similarity approach. For example, the correlated episode is identified as described previously with respect to FIG. 6B.

The system generates (718), via the pre-trained recommender model, a user embedding (e.g., the user embedding 506) based on a plurality of features of the user. In some embodiments, the plurality of features of the user includes (720) one or more of: a gender, an age, a country, a language, a recent topic liked, a streaming statistic, and a collaborative filtering vector.

The system generates (722), via the pre-trained recommender model, a respective episode embedding (e.g., the episode embedding 512) for each episode of a plurality of episodes, each respective episode embedding based on a plurality of features of the corresponding episode. In some embodiments, the plurality of features of the episode includes (724) one or more of: a topic, a country, a language, a licensor, a publisher, a collaborative filtering vector, and a semantic embedding.

The system generates (726), via the pre-trained recommender model, a respective similarity score (e.g., the similarity score 514) for each episode of a plurality of episodes, the respective similarity score corresponding to a latent similarity between the user embedding and each respective episode embedding.

In some embodiments, the plurality of episodes consists of (728) episodes with which the user has not previously interacted (e.g., discovery episodes that the user has not interacted with previously).

The system ranks (730) the plurality of episodes in accordance with the respective similarity scores. For example, the system ranks respective similarity scores 514 using the ranker 329.

The system recommends (732) a highest ranked episode of the plurality of episodes to the user. For example, the media content server 104 and/or the electronic device 102 recommend a highest ranked discovery episode to a user of the electronic device 102.

Although FIGS. 7A-7B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In one aspect, some embodiments include a method (e.g., the method 700) of recommending content to a user. The method is performed at a computing device (e.g., the electronic device 102 or the media content server 104) having one or more processors and memory. The method includes: (1) obtaining a pre-trained recommender model (e.g., the discovery model 227 or 322), where the pre-trained recommender model is trained using contrastive learning with feature-level augmentation and instance-level augmentation (e.g., via the augmenter(s) 328); (2) generating (e.g., using the user embedder 324), via the pre-trained recommender model, a user embedding (e.g., the user embedding 506) based on a plurality of features of the user (e.g., the user features 504); (3) generating (e.g., via the episode embedder 326), via the pre-trained recommender model, a respective episode embedding (e.g., the episode embedding 512) for each episode of a plurality of episodes, each respective episode embedding based on a plurality of features of the corresponding episode (e.g., the episode features 510); (4) generating, via the pre-trained recommender model, a respective similarity score (e.g., the similarity score 514) for each episode of a plurality of episodes, the respective similarity score corresponding to a latent similarity between the user embedding and each respective episode embedding; (5) ranking the plurality of episodes (e.g., using the ranker 329) in accordance with the respective similarity scores; and (6) recommending a highest ranked episode of the plurality of episodes to the user (e.g., presenting the highest ranked episode at the electronic device 102). As an example, the recommended episodes 412 are presented to the user at the electronic device 102.

(A2) In some embodiments of A1, the plurality of episodes consists of episodes with which the user has not previously interacted (e.g., the discovery episodes 408). For example, episodes of shows with which the user has not previously interacted (e.g., a show that the user has not seen).

(A3) In some embodiments of A1 or A2, the pre-trained recommender model is a two-tower model having a user function and an episode function (e.g., as described previously with respect to FIG. 5).

(A4) In some embodiments of any of A1-A3, the feature-level augmentation comprises generating augmented episode embeddings by masking subsets of the plurality of features of the corresponding episodes (e.g., as described previously with respect to FIG. 6A).

(A5) In some embodiments of any of A1-A4, the instance-level augmentation comprises identifying a correlated episode for an episode of the plurality of episodes and generating a correlated episode embedding for the correlated episode (e.g., as described previously with respect to FIG. 6B).

(A6) In some embodiments of A5, generating the correlated episode embedding comprises applying a feature-level augmentation (e.g., via the dropout layer 614) to the features of the correlated episode.

(A7) In some embodiments of A5 or A6, the correlated episode is identified using one or more of: a semantic similarity approach (e.g., via a transformer model), a knowledge graph similarity approach, and a cosine similarity approach. In some embodiments, the correlated episode is identified as described previously with respect to FIG. 6B.

(A8) In some embodiments of A7, the semantic similarity approach includes using a nearest neighbor search (e.g., an approximate nearest neighbor search).

(A9) In some embodiments of any of A1-A8, the plurality of features of the user include one or more of: a gender, an age, a country, a language, a recent topic liked, a streaming statistic, and a collaborative filtering vector. In some embodiments, the plurality of features of the user includes one or more features based on historical interactions (e.g., the historical interactions 404) of the user.

(A10) In some embodiments of any of A1-A9, the plurality of features of the episode include one or more of: a topic, a country, a language, a licensor, a publisher, a collaborative filtering vector, and a semantic embedding.

In another aspect, some embodiments include a computing system including one or more processors and memory coupled to the one or more processors, the memory storing one or more programs configured to be executed by the one or more processors, the one or more programs including instructions for performing any of the methods described herein (e.g., the method 700 or A1-A10 above).

In yet another aspect, some embodiments include a non-transitory computer-readable storage medium storing one or more programs for execution by one or more processors of a computing system, the one or more programs including instructions for performing any of the methods described herein (e.g., the method 700 or A1-A10 above).

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method of recommending content to a user, the method comprising:
at a computing device having one or more processors and memory:
obtaining a pre-trained recommender model, wherein the pre-trained recommender model is trained using contrastive learning with feature-level augmentation and instance-level augmentation;
generating, via the pre-trained recommender model, a user embedding based on a plurality of features of the user;
generating, via the pre-trained recommender model, a respective episode embedding for each episode of a plurality of episodes, each respective episode embedding based on a plurality of features of the corresponding episode;
generating, via the pre-trained recommender model, a respective similarity score for each episode of the plurality of episodes, the respective similarity score corresponding to a latent similarity between the user embedding and each respective episode embedding;
ranking the plurality of episodes in accordance with the respective similarity scores; and
recommending a highest ranked episode of the plurality of episodes to the user.

2. The method of claim 1, wherein the plurality of episodes consists of episodes with which the user has not previously interacted.

3. The method of claim 1, wherein the pre-trained recommender model is a two-tower model having a user function and an episode function.

4. The method of claim 1, wherein the feature-level augmentation comprises generating augmented episode embeddings by masking subsets of the plurality of features of the corresponding episodes.

5. The method of claim 1, wherein the instance-level augmentation comprises identifying a correlated episode for an episode of the plurality of episodes and generating a correlated episode embedding for the correlated episode.

6. The method of claim 5, wherein generating the correlated episode embedding comprises applying a second feature-level augmentation to the features of the correlated episode.

7. The method of claim 5, wherein the correlated episode is identified using a semantic similarity approach.

8. The method of claim 7, wherein the semantic similarity approach comprising using a nearest neighbor search.

9. The method of claim 5, wherein the correlated episode is identified using a knowledge graph similarity approach.

10. The method of claim 5, wherein the correlated episode is identified using a cosine similarity approach.

11. The method of claim 1, wherein the plurality of features of the user include one or more of: a gender, an age, a country, a language, a recent topic liked, a streaming statistic, and a collaborative filtering vector.

12. The method of claim 1, wherein the plurality of features of the episode include one or more of: a topic, a country, a language, a licensor, a publisher, a collaborative filtering vector, and a semantic embedding.

13. A computing device, comprising:
one or more processors;
memory; and
one or more programs stored in the memory and configured for execution by the one or more processors, the one or more programs comprising instructions for:
obtaining a pre-trained recommender model, wherein the pre-trained recommender model is trained using contrastive learning with feature-level augmentation and instance-level augmentation;
generating, via the pre-trained recommender model, a user embedding based on a plurality of features of the user;
generating, via the pre-trained recommender model, a respective episode embedding for each episode of a plurality of episodes, each respective episode embedding based on a plurality of features of the corresponding episode;
generating, via the pre-trained recommender model, a respective similarity score for each episode of a plurality of episodes, the respective similarity score corresponding to a latent similarity between the user embedding and each respective episode embedding;
ranking the plurality of episodes in accordance with the respective similarity scores; and
recommending a highest ranked episode of the plurality of episodes to the user.

14. The device of claim 13, wherein the plurality of episodes consists of episodes with which the user has not previously interacted.

15. The device of claim 13, wherein the pre-trained recommender model is a two-tower model having a user function and an episode function.

16. The device of claim 13, wherein the feature-level augmentation comprises generating augmented episode embeddings by masking subsets of the plurality of features of the corresponding episodes.

17. The device of claim 13, wherein the instance-level augmentation comprises identifying a correlated episode for an episode of the plurality of episodes and generating a correlated episode embedding for the correlated episode.

18. A non-transitory computer-readable storage medium storing one or more programs configured for execution by a computing device having one or more processors and memory, the one or more programs comprising instructions for:
obtaining a pre-trained recommender model, wherein the pre-trained recommender model is trained using contrastive learning with feature-level augmentation and instance-level augmentation;
generating, via the pre-trained recommender model, a user embedding based on a plurality of features of the user;
generating, via the pre-trained recommender model, a respective episode embedding for each episode of a plurality of episodes, each respective episode embedding based on a plurality of features of the corresponding episode;
generating, via the pre-trained recommender model, a respective similarity score for each episode of a plurality of episodes, the respective similarity score corresponding to a latent similarity between the user embedding and each respective episode embedding;
ranking the plurality of episodes in accordance with the respective similarity scores; and
recommending a highest ranked episode of the plurality of episodes to the user.

19. The non-transitory computer-readable storage medium of claim 18, wherein the feature-level augmentation comprises generating augmented episode embeddings by masking subsets of the plurality of features of the corresponding episodes.

20. The non-transitory computer-readable storage medium of claim 18, wherein the instance-level augmentation comprises identifying a correlated episode for an episode of the plurality of episodes and generating a correlated episode embedding for the correlated episode.
